(19) United States
(12) Patent Application Publication
(10) Pub. No.: US 2014/0317435 A1
(43) Pub. Date: Oct. 23, 2014

(54) ELECTRONIC DEVICE AND METHOD FOR TESTING CAPACITORS OF MOTHERBOARD OF ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: HUI LI, Shenzhen (CN)

(21) Appl. No.: 13/923,399

(22) Filed: Jun. 21, 2013

(30) Foreign Application Priority Data
Apr. 22, 2013 (CN) 2013101430534

(51) Int. Cl. G06F 11/07

(52) U.S. Cl. CPC G06F 11/0706
USPC 714/3

(57) ABSTRACT

In a method for testing the locations and identities of capacitors of a motherboard of an electronic device, register addresses of the capacitors of the motherboard are detected and a notification is generated if all the detected register addresses are correct. Each capacitor having an incorrect register address is reconfigured with a correct register address. The configuration report is generated recording the reconfiguration of the capacitors, and the electronic device is then powered off.

### BACKGROUND

1. Technical Field

The embodiments of the present disclosure relate to systems and methods for testing electronic devices, more particularly to an electronic device and method for testing capacitors of a motherboard of the electronic device.

2. Description of Related Art

Register addresses of capacitors if motherboards of electronic devices are configured during development of the electronic devices. However, the register addresses of the capacitors may be wrongly configured, or the capacitors may fall off the motherboards during transport so that the motherboards of the electronic devices do not pass quality control and the electronic devices cannot be powered on.

### BRIEF DESCRIPTION OF THE DRAWINGS

FIG. 1 is a block diagram of one embodiment of an electronic device including a capacitor testing system.

FIG. 2 is a block diagram of one embodiment of function modules of the capacitor testing system in FIG. 1.

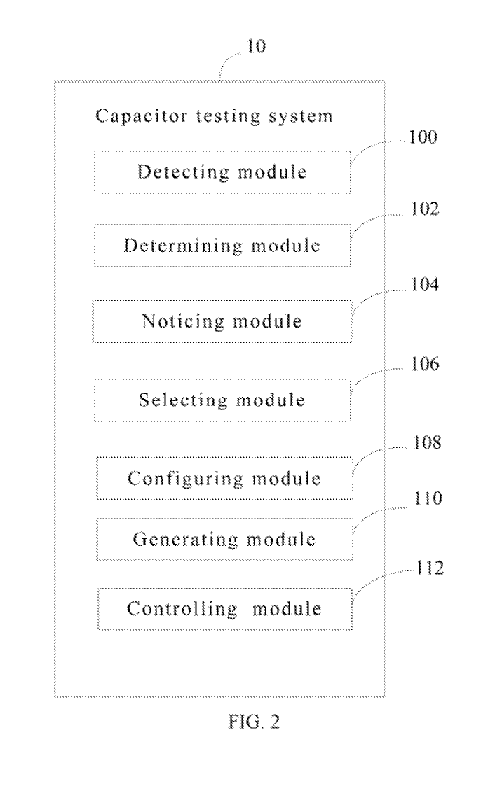

FIG. 3 is a flowchart of one embodiment of a method for testing capacitors of a motherboard of the electronic device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware, firmware, or to a collection of software instructions written in a programming language. In one embodiment, the programming language may be Java, C, or assembly. One or more software instructions in the modules may be embedded in firmware, such as in an EPROM. The modules described herein may be implemented as software and/or hardware modules and may be stored in any type of non-transitory computer-readable medium or other storage device. Some non-limiting examples of non-transitory computer-readable media include CDs, DVDs, flash memory, and hard disk drives.

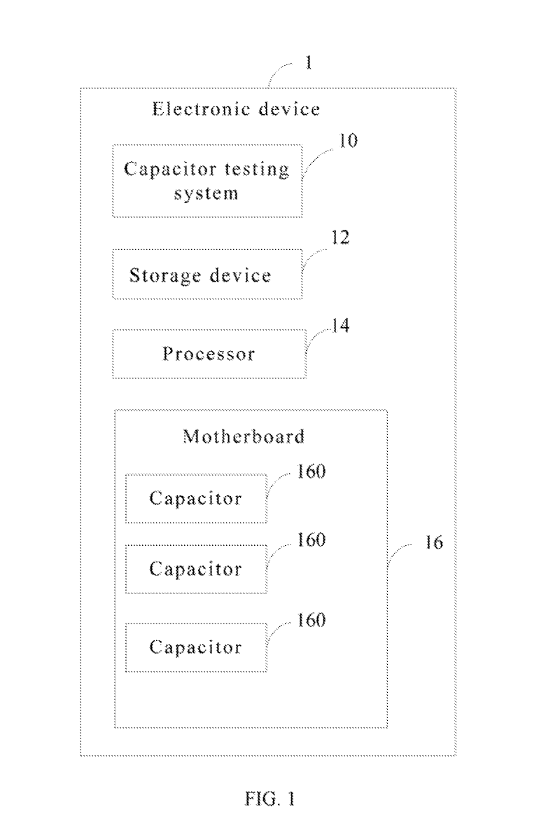

FIG. 1 is a block diagram of one embodiment of an electronic device 1 including a capacitor testing system 10. The electronic device 1 comprises a storage device 12, at least one processor 14, and a motherboard 16. The electronic device 1 may be a PDA device, a tablet computer, or the like.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system such as an external hard disk, a storage card, or a data storage medium.

At least one processor 14 may include a processor unit, a microprocessor, an application-specific integrated circuit, a field programmable gate array, or the like.

A plurality of capacitors 160 are installed on the motherboard 16. When the motherboard 16 is powered on, a Basic Input/Output System (BIOS) of the electronic device 1 detects registered address of all the capacitors 160.

In one embodiment, the capacitor testing system 10 includes a plurality of function modules, which include computerized codes or instructions that are stored in the storage device 12 and executed by the at least one processor 14 to provide a method for testing the capacitors 160.

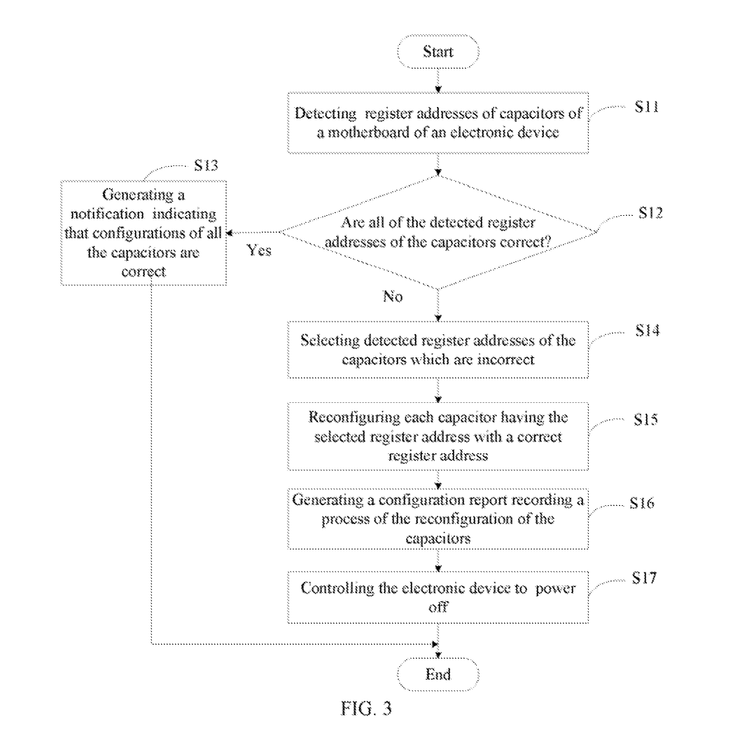

In one embodiment, the capacitor testing system 10 includes a detecting module 100, a determining module 102, a noticing module 104, a selecting module 106, a configuring module 108, a generating module 110, and a controlling module 112. The modules comprise computerized codes in the form of one or more programs that are stored in the storage device 12 and executed by the processor 14 to carry out functions for implementing the modules. The functions of the function modules are illustrated in FIG. 3 and described below.

FIG. 3 illustrates a flowchart of one embodiment of a method for testing the capacitors 160 of the motherboard 16 of the electronic device 1. Depending on the embodiment, additional steps may be added, others removed, and the ordering of the steps may be changed.

In block S11, the detecting module 100 detects register addresses of the capacitors 160 of the motherboard 16 of the electronic device 1. The register addresses of the capacitors 160 of the motherboard 16 may be detected by the BIOS of the electronic device 1.

In block S12, the determining module 102 determines whether all the detected register addresses of the capacitors 160 are correct. If all the detected register addresses of capacitors 160 are correct, S13 is implemented. If any detected register address of one of the capacitors 160 is incorrect, S14 is implemented. In the embodiment, the determining module 102 determines whether a register address of each capacitor 160 is correct by comparing the detected register address of each capacitor 160 with a correct register address stored in the storage device 12 in advance. The correct register address may be a register address configured in the development process of the electronic device 1 so that the motherboard 16 passes quality control and the electronic device 1 can be powered on.

In block S13, the noticing module 104 generates a notification indicating that configurations of all the capacitors 160 are correct. The notification may be displayed as “pass” pass on a display screen of the electronic device 1.

In block S14, the selecting module 106 selects the detected register addresses that are incorrect.

In block S15, the configuring module 108 reconfigures each selected capacitor 160 with the correct register address.

In block S16, the generating module 110 generates a configuration report on the reconfiguration of the capacitors 160. The configuration report includes an ID number of each of the capacitors 160 and their correct register addresses.

In block S17, the controlling module 112 controls the electronic device 1 to power off.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one processor, causes the at least one processor to:
detect register addresses of capacitors of a motherboard of the electronic device;
determine whether all of the detected register addresses of the capacitors are correct;
generate a notification indicating that configurations of all the capacitors are correct if all the detected register addresses of the capacitors are correct;
select detected register addresses of the capacitors which are incorrect if the detected register addresses of the capacitors are incorrect;
reconfigure each capacitor having the selected register address with a correct register address;
generate a configuration report recording a process of the reconfiguration of the capacitors; and
control the electronic device to power off.

2. The electronic device according to claim 1, wherein whether the register address of each capacitor is correct is determined by comparing the detected register address of each capacitor with the correct register address stored in the storage device.

3. The electronic device according to claim 2, wherein the correct register address is a register address configured in a development process of the electronic device.

4. The electronic device according to claim 1, wherein the configuration report includes an ID number of each of the capacitors, and a correct register address of each of the capacitors.

5. The electronic device according to claim 1, wherein the notification is displayed as “pass” on a display screen of the electronic device.

6. A method for testing capacitors on a motherboard of the electronic device, the method comprising:
detecting register addresses of capacitors of the motherboard of the electronic device;
determining whether all of the detected register addresses of the capacitors are correct;
generating a notification indicating that configurations of all the capacitors are correct if all the detected register addresses of the capacitors are correct;
selecting the detected register addresses of the capacitors which are incorrect if the detected register addresses of the capacitors are incorrect;
reconfiguring each capacitor having the selected register address with a correct register address;
generating a configuration report recording a process of the reconfiguration of the capacitors; and
controlling the electronic device to power off.

7. The method according to claim 6, wherein whether the register address of each capacitor is correct is determined by comparing the detected register address of each capacitor with the correct register address stored in a storage device of the electronic device.

8. The electronic device according to claim 7, wherein the correct register address is a register address configured in a development process of the electronic device.

9. The method according to claim 6, wherein the configuration report includes an ID number of each of the capacitors, and correct register address of each of the capacitors.

10. The method according to claim 6, wherein the notification is displayed as “pass” on a display screen of the electronic device.

11. A non-transitory computer-readable storage medium having stored thereon instructions being executed by a processor of an electronic device, causes the electronic device to perform a method for testing capacitors equipped on a motherboard of the electronic device, the method comprising:
detecting register addresses of capacitors of the motherboard of the electronic device;
determining whether all of the detected register addresses of the capacitors are correct;
generating a notification indicating that configurations of all the capacitors are correct if all the detected register addresses of the capacitors are correct;
selecting the detected register addresses of the capacitors which are incorrect if the detected register addresses of the capacitors are incorrect;
reconfiguring each capacitor having the selected register address with a correct register address;
generating a configuration report recording a process of the reconfiguration of the capacitors; and
controlling the electronic device to power off.

12. The storage medium according to claim 11, wherein whether the register address of each capacitor is correct is determined by comparing the detected register address of each capacitor with a correct register address stored in the storage device in advance.

13. The storage medium according to claim 12, wherein the correct register address is a register address configured in a development process of the electronic device.

14. The storage medium according to claim 11, wherein the configuration report includes an ID number of each of the capacitors, and correct register address of each of the capacitors.

15. The storage medium according to claim 11, wherein the notification is displayed as “pass” on a display screen of the electronic device.
